(19) United States
(12) Patent Application Publication
(10) Pub. No.: US 2023/0309570 A1
(43) Pub. Date: Oct. 5, 2023

(54) A CUTTING SYSTEM AND A METHOD FOR OPENING BELLY AND BREAST OF ANIMAL CARCASSES SUCH AS PIG CARCASSES

(71) Applicant: MAREL RED MEAT B.V., Lichtenvoorde (NL)

(72) Inventors: Arno Hermanus Maria UEFFING, Lichtenvoorde (NL); Maarten Christiaan HUININK, Lichtenvoorde (NL)

(21) Appl. No.: 18/011,708

(22) PCT Filed: Jul. 2, 2021
(86) PCT No.: PCT/EP2021/068381

§ 371 Date: Dec. 20, 2022

(30) Foreign Application Priority Data
Jul. 3, 2020 (EP) 20183940.4
Oct. 30, 2020 (DK) PA 2020 70722

(51) Int. Cl. A22B 5/00

(52) U.S. Cl. CPC A22B 5/0023; A22B 5/0041

(57) ABSTRACT

A method and a cutting system are provided for opening belly and breast of animal carcasses. The system includes a first cutting device capable of cutting open the belly and breast along the ventral side of an animal carcass. A guide pin is capable of being directed along the inside of the carcass abdominal wall and capable of providing a first force on the inside of the carcass belly. At least one pressure device is capable of providing a second force on the outside of the carcass belly, breast and/or neck. The pressure device is fixed or movable at least in the direction of the first and second force.

### FIELD OF THE INVENTION

The present invention relates to a cutting system and a method for opening belly and breast of animal carcasses such as pig carcasses. The cutting system can also cut the throat of the carcass.

### BACKGROUND

When cutting open belly and breast of carcasses at slaughterhouses, such as cutting open belly and breast of pig carcasses hanging in the hind legs, a belly opener with a knife is directed towards the abdominal wall of a carcass and cuts from the pubic bone towards the throat of the carcass.

A system for cutting open belly and breast is described in WO 2014/025250 which discloses a slaughtering tool with a rotatable cutting blade which is partially shielded, and which shielding is provided with a protruding guide pin. A further slaughtering tool is a cleaving blade to split the pubic bone of the carcass. The cleaving blade is attached to the shield that partially covers the rotatable cutting blade.

The forces applied on the hanging carcass such as by a belly opener destabilizes the hanging carcass making it difficult for the system handling the belly opener to perform a straight cut in the belly, breast and/or part of the ventral side of the neck towards the throat. This is a problem, which partly has been solved by systems for stabilizing the carcass, which systems are located along part of the dorsal part of the carcass, however, the dorsal stabilization systems only stabilize the carcass in respect of forces applied to the carcass, where the forces push the carcass towards the dorsal stabilization system. Situations occur during cutting open belly and breast of carcasses, where forces are applied to the carcass and these forces are not only pushing the carcasses towards the dorsal stabilization system to stabilize the carcass, but rather the forces de-stabilize the carcasses by making the carcass swinging. In these situations, a non-straight cut in the belly and/or breast part of the carcass may occur making e.g. a non-symmetrical or out-of-middle splitting of the carcass. Such non-straight cuts and non-symmetrical splitting reduces the quality of the cut products.

### DESCRIPTION OF THE INVENTION

The present invention solves the above-mentioned problem by providing a cutting system for opening belly and breast of animal carcasses, where the cutting system is capable of stabilizing a carcass during the cutting process where the carcass may be hanging with the head downwards. When using the system, a straight cut can be obtained, which improves the quality of the products produced. A straight and symmetrical cut preferably leads all the way from the pubic bone to the pharynx and/or to the stick hole if sticking was used to kill the animal, and if the stick was located correctly. Symmetrical means the cut divide the ventral part of a carcass into two symmetrical parts. A straight and symmetrical cut also has the benefit of an easier removal of the red organs located in the breast region because of less manual work for operators, and thus also cost saving, less meat loss during stick hole cleaning where meat is cut away around the stick hole, and a better performance of the saw in the carcass splitter splitting the dorsal part of the carcass in a subsequent process.

The cutting system described herein can be used for opening belly and breast of animal carcasses that are being moved e.g. transported in a conveyor system where the carcasses e.g. are hanging in their hind legs. In such a situation a carcass and the cutting system are preferably moving together with similar speed in the transport direction of the carcasses. Such a synchronized movement makes it difficult to stabilize a carcass during opening the belly and breast of the carcass.

An aspect of the invention relates to a cutting system for opening belly and breast of animal carcasses such as pig carcasses, the system comprises at least:
a) A first cutting device capable of cutting open the belly and breast along the ventral side of an animal carcass, and
b) At least one guide pin located next to a cutting area of the first cutting device, the guide pin being capable of being directed along the inside of the carcass abdominal wall and capable of providing a first force on the inside of the carcass belly in at least a direction towards the cutting area of the first cutting device when the first cutting device is in function, and
c) At least one pressure device located relative to the first cutting device when the first cutting device is in function, such that the at least one pressure device provides a second force on the outside of the carcass belly and/or breast and/or neck, the second force being at least in a direction opposite of the first force, and the first and second force are acting in the processing area.

By having the first and second force acting in the processing area, they are providing a local pulling and pushing effect in the processing area i.e. in the cutting area on the carcass. The effect of the first and second force is a stabilizing of at least the processing area of the carcass, which may be transported by a conveyor during the cutting process. The local pulling and pushing effect preferably neutralize each other by having a local effect in the processing area. In overall the effect is that a straight cut is possible to make all along the ventral side of the carcass including a straight cut in the neck and throat. In the system the at least one pressure device may be seen as a steering device which preferably steers the cutting system to perform the cut in the middle of the carcass.

In an embodiment, the invention relates to a cutting system wherein the pressure device is movable at least in the direction of the first and second force. The pressure device may also be fixed in relation to the first cutting device.

The pressure device is configured to make contact with the outside of the carcass skin on the ventral side of the carcass during opening the belly and breast of the carcass.

Preferably the at least one, such as two, pressure devices make a pressure or counterforce on the skin side of the carcass very close to the location of the guide pin located on the inside of the abdominal wall. Hereby a local pulling and pushing effect is obtained due to the forces provided by the guide pin and the at least one pressure device, and the belly skin is lifted to the cutting area from inside and outwards. By lifting the skin in this way, the risk of damaging the intestines are reduced compared to when the skin is not lifted, this reduction of the risk of damaging the intestines is also present if the angle between the guide pin and the abdominal wall is changed during cutting. Changing the angle may be performed by turning the cutting system in the vertical plane and keeping the first cutting device in the correct position cutting along the ventral side of the carcass.

The supporting surface of the pressure device(s) and the guide pin are when in function preferably located close to each other to be capable of providing the local pulling and pushing. The guide pin is preferably located across the pre-determined cutting line, and the supporting surfaces are preferably located close to the guide pin either above or below the guide pin, or on both sides of the cutting line e.g. horizontally displaced relative to the guide pin. Preferably the number of supporting surfaces is even, such as 2 or 4, and the supporting surfaces are preferably located mirrored determined in relation to a vertical line such as the pre-determined cutting line.

The at least one supporting surface may be positioned onto the skin surface within a distance from the tip of the guide pin corresponding to less than a radius of the first cutting device when the first cutting device is circular. This distance between the guide pin and the supporting surface of a pressure device may also be less than 20 cm, e.g. less than 15 cm, such as less than 10 cm, e.g about 5 cm.

Local pulling and pushing may be obtained when the at least one guide pin and the at least one supporting surface are positioned as described elsewhere herein. Indication of local pulling and pushing may be that the abdominal wall is pressed or deformed in an S-shape relative to a guide pin and a supporting surface. The local pulling and pushing can also be obtained e.g. when the first and second forces are provided almost in one horizontal line.

In the cutting system the pressure device may be movable or fixed. Both solutions have their own advantages. For the movable pressure device, the force applied to the outside of the carcass skin may be regulated by a regulator in response to different indications such as location along the cutting line when cutting the abdominal wall along the belly. The movable pressure device may also be in a retracted position e.g. during a washing process, hereby reducing the total outer volume which has to be treated in the washing and rinsing processes which may e.g. be performed in a cabinet arranged in connection to the cutting system, such as a system with at least two cutting systems as described herein and such that when one system is in function at least another cutting system is in the washing process.

For cutting systems where the pressure device is fixed the system may be simpler than the cutting system with movable pressure device. This may reduce the production costs when producing the system. A system with fixed pressure device(s) may be preferred at some abattoirs as it may be believed a fixed pressure device is easier cleaned and more reliable as it may result in less break down of the system when compared to a system with a movable pressure device.

With first force is meant providing a first force on the inside of the carcass belly in at least a direction towards the cutting area of the first cutting device and with second force is meant providing a second force on the outside of the carcass belly and/or breast and/or ventral part of the neck, the second force being at least in a direction opposite of the first force. Preferably the second force provided by the supporting surfaces presses the carcass abdominal wall towards the at least one guide pin during cutting of the abdominal wall, hereby making a local pushing and pulling, relatively, of the abdominal wall in the area of the guide pin and the supporting surfaces.

The pressure device provides the second force on the outside of the carcass, and may function as a counter hold or backstop for the pressure provided by the at least one guide pin when this guide pin is directed inside the abdominal wall along the belly part of the carcass, and where the guide pin when performing the first force makes a distance between the abdominal wall and the intestines, hereby making it possible for the first cutting device to cut open the abdominal wall in the belly region and preferably cutting without damaging the intestines. If during this process, the guide pin is performing too much force to the inside of the abdominal wall it may be observed as a pulling effect on the carcass and hereby un-stabilizing the carcass which may result in an irregular cutting. With the pressure device performing the second force onto the skin side of the abdominal wall, the carcass is stable and a cut along the belly part may be performed in a straight line.

In an embodiment the pressure device may comprise at least one, such as two or more supporting surfaces configured to provide the second force to the outside of the skin of the carcass. In a system with at least two supporting surfaces these supporting surfaces may be located symmetrically in relation to the guide pin, such that the supporting surfaces are preferably located on either side of a cutting line when the system is in function or may be located symmetrically in front of a cutting device making a cutting line. When using the formulation ‘on each side of a/the cutting line’ when describing the location of the supporting surfaces this means the supporting surfaces are located on each side of where a cutting line will be made by a cutting device i.e. the at least two supporting surfaces are spaced apart.

The number of supporting surfaces may be any number, such as an even number, hereby easily providing equal force on each side of a cutting line performed by the first cutting device. When the system is in function opening a belly of a carcass, the supporting surfaces may be ahead of, at the line of, and/or behind the guide pin. In a preferred embodiment the supporting surfaces are ahead of the guide pin and the first cutting device. The at least two supporting surfaces are spaced apart and located on each side of a cutting line to be made by the first cutting device to perform the second force onto the skin surface and to prevent rotation or twisting of the carcass and also to prevent swinging of the carcass such as in the belly-back direction. In a preferred embodiment lines between two symmetrically located supporting surfaces together with lines from each of these to the guide pin form a triangle.

In principle what is described herein as two supporting surfaces may be constructed as one supporting surface if the supporting surface has a supporting surface extending across the cutting line made or the cutting line to be made, hereby supporting the carcass on each side of this cutting line before or after the cutting is made.

In an embodiment the at least one pressure device comprises at least one supporting surface configured to provide the second force to the outside of the skin of the carcass and where the supporting surface may be one or more slides or one or more rollers. The supporting surfaces may be designed to combine the functioning of being capable of pressing towards the skin surface and simultaneously sliding over the skin surface, hereby being slides. However, the supporting surfaces may also be designed to combine the functioning of being capable of pressing towards the skin surface and simultaneously rolling over the skin surface, hereby being rollers.

In a preferred embodiment the supporting surfaces are one roller on each side of the cutting line which may also be described as one roller on each side of the cutting device and/or on each side of the guide pin, though the rollers are preferably located offset of the cutting device and/or offset of the guide pin. One roller on each side of the pulling line or cutting device may be two independent rollers or it may be one diabolo roller or diabolo wheel with one protruding circular part one each side of a common middle part. Only one roller in total may be used, but to improve stability when the system is directed along a carcass, at least one roller on each side of the cutting line is preferable. Such two rollers preferably are positioned parallel to each other and with similar center axis around which the rollers may rotate. However, when in function the rollers may act independently of each other to follow the skin surface and hereby in overall be parallel though temporarily being slightly offset to each other by having different center axes.

Also, two rollers on each side of a cutting line is possible i.e. in total four rollers may be used. Such two rollers may be positioned parallel to each other and with similar center axis. With two rollers on each side of the cutting line, such two rollers may have similar center axis during the entire process, or they may be capable of function independently to follow the skin surface.

Supporting surfaces in the form of rollers may be preferred, as these easily can pass over irregularities in/on the skin surface of a carcass and hereby not stick to the skin such as to the stick hole.

The location of the at least one guide pin and the at least one pressure device relative to each other are preferably such that the first force and second force interact with each other when the tools are working in the belly area of a carcass. The at least one pressure device need not be located close to the guide pin, but for technical and technological reasons it is preferred to keep the at least one pressure device rather close to the guide pin. The force applied to the inside of the belly should be capable of being felt and/or seen on the outside skin side of the carcass.

In an embodiment the system may further comprise a pressure adjusting device connected to the pressure device and configured to adjust the pressure made by the supporting surfaces towards the outer skin surface of a carcass. The pressure adjusting device may be a spring or a cylinder such as an air cylinder. A cylinder may be controlled by a controller which may be in contact with and receive information from one or more items or sensors in a communication system as described elsewhere herein for obtaining information in respect of one or more items selected from the group of the position of at least one pressure device, position of at least one supporting surface, position of the guide pin, contour of the outer skin surface located in between at least two supporting surfaces. The pressure adjusting device may be controlled to perform a second pressure onto the skin surface, and the applied force may be adjusted due to where on the carcass the cutting process is performed i.e. in the belly region, in the breast region or in the neck region and/or in the head region. The second force is adjusted to reflect when the second force is provided in a region with belly fat or in a region with ribs/sternum or in the neck region, respectively. The type of operation is different in these regions due to the different compositions of the carcass with a softer belly region and a harder breast region and a neck region where it is difficult to perform a symmetrical cut.

The system may further comprise a position adjusting device to adjust the position of the pressure device and be configured to adjust the position of the supporting surfaces such as on the outside of the carcass skin in an advanced position or the supporting surfaces may be in a retracted position where the position adjusting device has moved the supporting surfaces away from the outside of the carcass skin surface. A retracted position may be a partly or fully retracted position. When fully retracted the supporting surfaces are positioned as far away from the carcass skin surface as possible, and this may be the position of the movable supporting surfaces when the system is used for cutting through a pubic bone as described elsewhere herein. The retracted position may also be the position for the supporting surfaces during a washing process as described elsewhere herein.

The pressure adjusting device and the position adjusting device may be different devices function independently though still in cooperation to each other, or they may be integrated into one single device which includes both functions i.e. being one common device.

In an embodiment the supporting surfaces may be adjustable in respect of distance to each other e.g. in respect of horizontal or vertical distance determined in relation to the positions during cutting. The position adjusting devices may control the distance of the supporting surfaces in the three dimensions x, y, z to obtain the correct positioning of the supporting surfaces in relation to each other, in relation to the location of the guide pin and in relation to the dimension of the carcass to process.

In an embodiment the system is connected to a controller which can be controlling at least the pressure adjusting device and/or the position adjusting device.

The system described herein may function such that the pressure adjusting device controls the pressure device to act as a counter hold for the guide pin when the first cutting device cuts into the belly skin and/or the pressure adjusting device controls the pressure device to act as a pushing device pushing onto the outside of the carcass skin and hereby eliminate or reduce twisting of the carcass when the pressure device is passing along the breast of the carcass. When the pressure device is used as a pushing device and is being directed along the breast part of the carcass the carcass may be pushed towards one or more guides located at the dorsal part of the carcass, hereby the carcass is stabilized, and a proper cut can be made through the sternum.

In an embodiment the system may further comprise a second cutting device configured to cut through or split a pubic bone of a carcass. The second cutting device may be a straight knife and may be designed to be secured to a second cutter holder which may be capable to hold the second cutting device in a fixed position related to the first cutting device and the at least one guide pin. The second cutting device may also be denoted a pre-cutter. When in function the second cutting device is stabbed into the carcass in the groin area just above the pubic bone, then it is moved downwards and opens the pubic bone and following this the second cutting device can be taken out of the carcass again.

In an embodiment the system comprises a controller or controlling device which may be in contact with one or more devices in the system for receiving information and for controlling such devices. Retrieval of information may be performed by sensors in the system such as a 3D vision system comprising cameras focusing on and scanning relevant parts of the carcasses to be handled and positioned e.g. to perform 3D scanning at least of the abdominal wall to be cut. The controlling device receives information from one or more sensors e.g. in a 3D vision system or other devices in the system, perform calculations including cutting path calculation based on the received information and based on the calculations control one or more items of the system such as a manipulator e.g. a robot arm controlling the cutting system or at least the tool of the cutting system.

In another embodiment the system further comprises at least one robot or robot arm capable of working in three dimensions e.g. denoted X, Y and Z, such as working in a Cartesian system. The at least one robot or robot arm may have at least 3 degrees of freedom, such as 4, 5, 6 or 7 degrees of freedom, preferably 6 degrees of freedom. The at least one robot or robot arm is preferably controlled by the controlling device.

When the system is in function several sensors may scan a carcass and the obtained information e.g. image data can be converted to a precise movement of both the at least one robot or robot arm and cutting system to perform a straight cutting line through the abdominal wall from the pubic bone and at least to the end of the sternum and if the carcass are stabilized sufficiently the cutting line will be located such that the cut of the sternum will divide this into equal halves.

The system described herein may include a pre-cutter and a belly and breast opener which in one working round may split the pubic bone, open the abdominal wall and split the breastbone, and thus ensure an equal division of the two abdominal halves and breastbone halves of the pig, which may be hanging on a conveyor.

An embodiment of the system may include a cabinet with washing and rinsing devices into which cabinet a tool comprising at least the first cutting device, the at least one guide pin, and the at least one pressure device can be directed when the tool is not in function. Inside the cabinet the tool may be treated in a washing and rinsing process. Two tools may be arranged in the system where one tool can be located outside a cabinet and the other tool can be located inside the cabinet with washing and rinsing devices. Hereby one tool can be in function opening a carcass belly and breast and the other tool may be subjected to a washing and rinsing process. When working with the next carcass in a line the position of the two tools can be reversed, hereby securing cleaning and rinsing of each tool in between use. The system with two tools and a cabinet for washing and rinsing is especially suited when the system is combined with a robot or robot arm for moving a tool along the ventral side of carcasses such as in slaughterhouses.

An aspect of the invention relates to a method for cutting belly and breast of animal carcasses, such as pig carcasses, the method comprises at least the steps of:
a) Directing a guide pin behind abdominal wall at the pubic bone of a carcass and positioning the guide pin, such that the guide pin performs at least a first force pressing the belly skin outwards of the carcass,
b) Moving the guide pin along the inside of the abdominal wall keeping the at least first force and simultaneously providing at least a second force to the outside of the carcass skin, which second force is at least opposite the first force, and
c) Cutting the carcass abdominal wall by a first cutting device, which has a cutting area wherein the first and second force are acting in the processing area.

Before the guide pin can be directed behind the abdominal wall, such as inside the leaf lard of a carcass at the pubic bone, the carcass is opened and cut by a pubic bone cutter or pre-cutter leaving room to the guide pin when the pubic bone cutter is removed. In an embodiment of the method prior to step a) another step (“step aa)”) of pre-cutting can be included where the pubic bone of the pig carcasses is cut or split by a second cutting device.

The first force applied to the inside of the abdominal wall may be just enough to make a short distance e.g. a few millimeter distance between the inside of the abdominal wall and the intestines, as it is important to reduce the risk of cutting into the intestines. Though as the intestines are soft and may be filled with water and partly decomposed feed the intestine may be moved when the carcass is handled such as when directing the guide pin along the inside of the abdominal wall and a short distance between intestines and the abdominal wall applied by the first force may not be visible. Preferably the risk of cutting into the intestines should be as low as possible, preferably zero hereby having a distance between the inside of the abdominal wall and the intestines which secures the cutting device will not reach the intestines when cutting the abdominal wall.

The second force applied to the outside of the carcass skin preferably has the function as a stabilizing force stabilizing the carcass, e.g. if the carcass is hanging in the hind leg the second force may reduce or eliminate rotation and/or swinging of the carcass. The second force applied on a carcass may be changed during the cutting process to obtain a stabilized position of the carcass. The first cutting device provides a force to the carcass during the cutting, where part of this force is acting in the same direction as the applied second force from the pressure device. The amount of applied force made by the first cutting device and acting in the same direction as the applied second force is different when cutting in the belly area and in the breast area, and the second force applied by the pressure device is preferably adjusted in respect of the force applied by the first cutting device to keep the carcass stabilized throughout the cutting process.

In an embodiment the method comprises the further step of
d) When the guide pin reaches the breast area, the second force is increased while the cutting device cuts through the sternum or breast bones.

The cut in step d) is preferably performed until the end of the sternum or preferably until the stick hole present in the neck of the carcass, which stick hole was made during killing of the animal if this was included during the killing process. If the animal was killed without making a stick hole in the neck or such a stick hole is not located correctly and thus is located outside of a determined cutting line, then the cut may be performed until a pre-determined location along the neck of the carcass.

In an embodiment the method is an automatic method where sensors are used to locate the position of the carcass and/or at least locations selected from the group of: the entire carcass, the location of the hind legs, the area of the pubic bone, the area of the belly, the area of the breast, the area of the front legs, the area of the head. The scanning or data collection by sensors may be performed by an automatic scanning device scanning the entire carcass such as a 3D scan of the outside of a carcass e.g. by at least one vision system, at least one X-ray system, and/or at least one UltraSound system.

The animal carcasses subjected to the described method may especially be from animals used for human food and/or for animal feed, such as selected from the group of animals of pig, porcine animal, goats, sheep, cows, deer, red meat, four-legged slaughtered animals. Preferred is porcine animal such as pigs.

In an embodiment of the method the animal carcasses are hanging in a position with hind legs up and head down. This may be at a slaughterhouse where the animals are transported in overhead conveyors.

Embodiments and details of embodiments described in respect of the system may be combined with the method and embodiments described in respect of the method, and vice versa. The method may be performed with a system described herein.

### BRIEF DESCRIPTION OF THE DRAWINGS

FIG. 1 illustrates a side view of a tool of the cutting system and a cabinet into which the tool can be positioned.

FIG. 2 illustrates a side view of a tool with pressure device in a retracted position.

FIG. 3 illustrates a tool in a perspective view.

FIG. 4 illustrates the tool of the cutting system 1 seen from above.

FIG. 5A-5D illustrate examples of relative location of guide pin and supporting surfaces at the ventral side of a carcass.

FIG. 6A-6F illustrate the process of cutting open a belly and breast of a carcass with a cutting system according to the present invention.

FIG. 7 illustrates a side view of the cutting device with rollers as pressures surface.

FIG. 8 illustrates the cutting device with rollers as pressures surface.

### DETAILED DESCRIPTION OF THE DRAWINGS

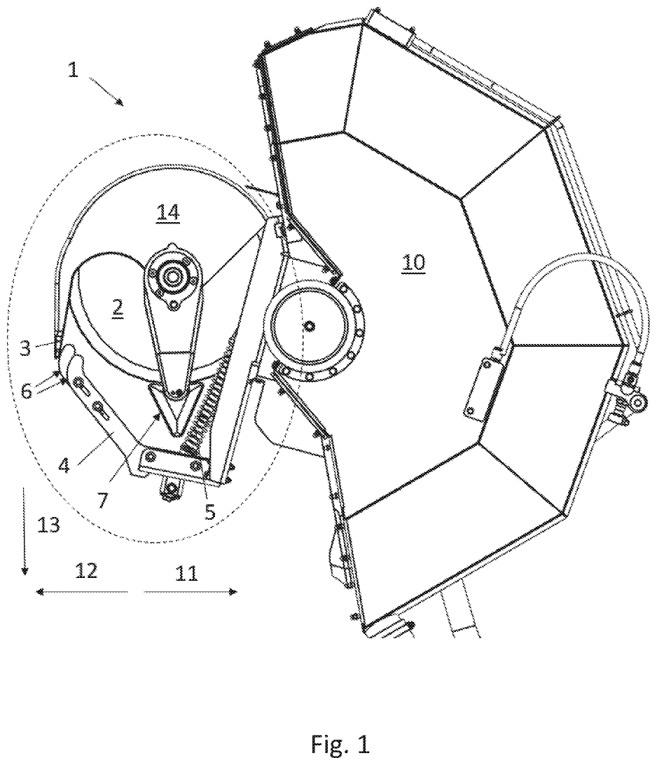

FIG. 1 illustrates a cutting system 1 according to the invention. Illustrated is a first cutting device 2 capable of cutting open the belly and breast along the ventral side of an animal carcass, a guide pin 3 located next to a cutting area of the first cutting device 2, the guide pin 3 being capable of being directed along the inside of the carcass abdominal wall and capable of providing a first force on the inside of the carcass belly in at least a direction towards the cutting area of the first cutting device i.e. substantially perpendicular to the moving direction of the guide pin 3 when the first cutting device 2 is in function. The arrow 11 illustrates the direction of the first force vector applied by the guide pin 3 when positioned inside the abdominal wall. Illustrated is also a pressure device 4 located at least in front of the cutting area of the first cutting device 2 when the first cutting device 2 is in function, the pressure device 4 being capable of providing a second force by supporting surfaces 6 on the outside of the carcass belly and breast, the second force being at least in a direction opposite of the first force. The arrow 12 illustrates the direction of the second force vector applied by the pressure guide 4 towards the skin side of the carcass. In this embodiment the pressure device 4 is movable at least in the direction of the first and second force i.e. in the directions illustrated by the arrows 11 and 12. Here the pressure device is illustrated in an advanced position corresponding to the position during a cutting process. A pressure adjusting device 5 is connected to the pressure device 4 and configured to adjust the pressure made by the supporting surfaces 6 towards the carcass. Also illustrated is a second cutting device 7 configured to cut the pubic bone before the guide pin 3 is directed behind the abdominal wall of a carcass. The second cutting device 7 is shielded by a shield 14 to which the guide pin 3 may be connected. The dotted line encircles a part of the cutting system 1 which part a tool of the system and which tool may be positioned inside a cabinet 10 to become washed and rinsed. The pressure device 4 is movable and is here shown in an extended position, which may correspond to the position of a fixed pressure device. Arrow 13 indicates the moving direction of the tool when in function cutting and opening a belly and breast of the carcass, hereby the arrow 13 also indicates the cutting direction of the cuts performed by the first cutting device 2 and by the second cutting device 7.

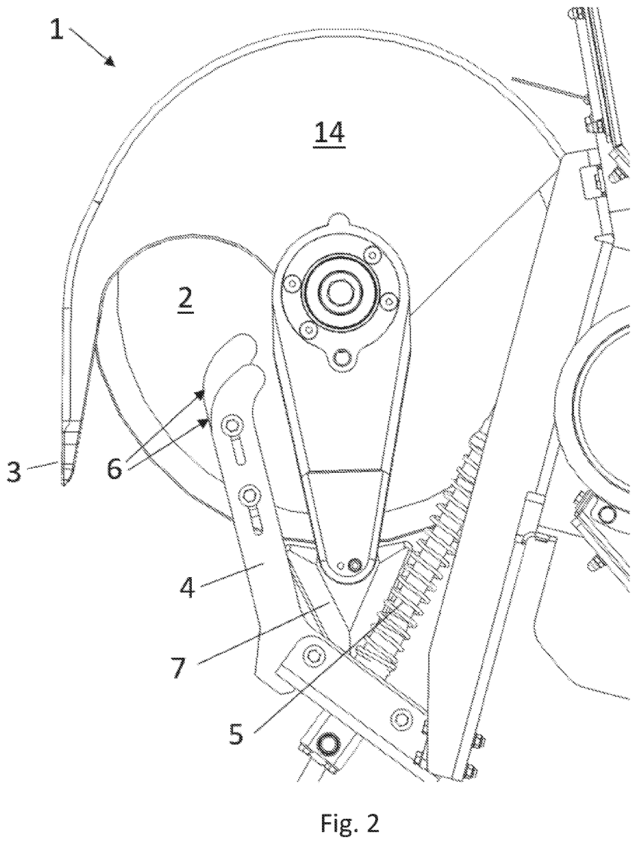

FIG. 2 illustrates the tool of the cutting system 1 where the pressure device 4 is in a retracted position. Reference numbers have same meaning as described in relation to FIG. 1.

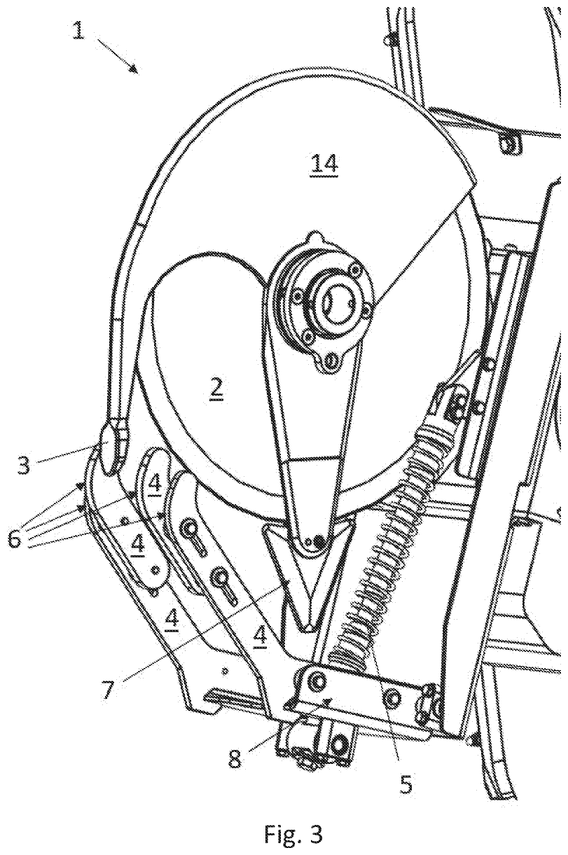

FIG. 3 illustrates the tool of the cutting system 1 in a perspective view where the supporting surfaces 6 of the pressure device 4 is located symmetrical on each side of the guide pin 3 and in this embodiment offset to the guide pin 3. Reference numbers have same meaning as described in relation to FIG. 1.

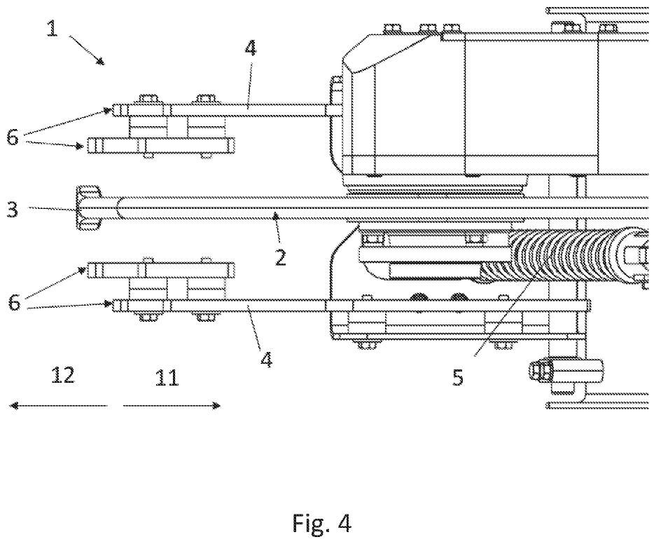

FIG. 4 illustrates the tool of the cutting system 1 seen from above. The pressure devices 4 are located symmetrically on each side of the first cutting device 2 and the guide pin 3. Each pressure guide 4 is in this embodiment designed with two supporting surfaces 6. The guide pin 3 when directed behind an abdominal wall of a carcass will perform a main force on the inside of the abdominal wall in the direction indicated by arrow 11, whereas the supporting surfaces 6 located on the skin outside of the carcass will provide a main force onto the skin surface in the direction indicated by arrow 12. The symmetrical design of the pressure devices 4 in respect to the first cutting device 2 and the guide pin 3 is not an absolute necessity, it is possible to design the pressure guide being primary located on one side of the first cutting device 2 and having supporting surfaces 6 located on each side of the guide pin 3—in a symmetrical or non-symmetrical design. Reference numbers have same meaning as described in relation to FIG. 1.

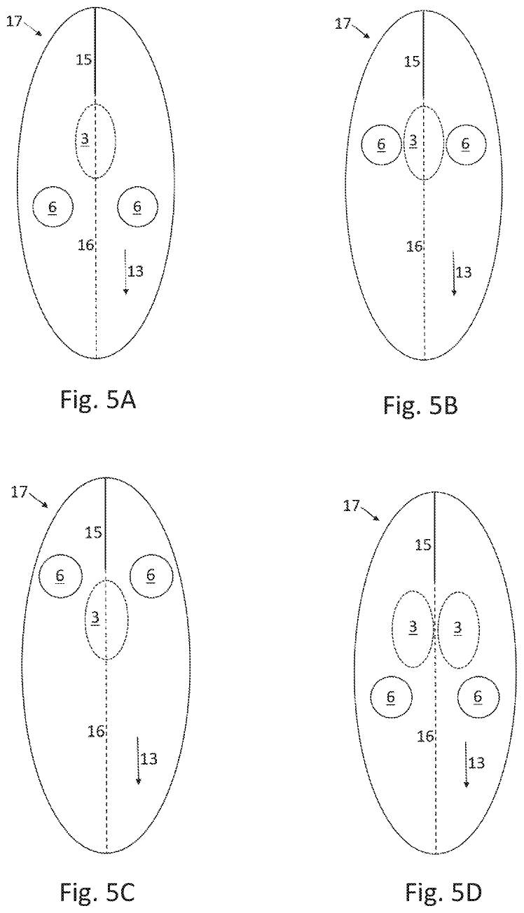

FIG. 5A-5D illustrate examples of relative location of guide pin and supporting surfaces at the ventral part of a carcass. In each of these figures an area 17 of the ventral side of a carcass is illustrated. This area 17 has been cut (the cutting device is not illustrated) along the cutting line 15 (the filled line) and is to be further cut along the calculated cutting line 16 (the dotted line). The arrow 13 illustrates the cutting direction. Some relative positions of guide pin 3 at the inside of the carcass and supporting device/surfaces 6 are indicated in the figures. FIG. 5A illustrates two supporting devices/surfaces 6 in front of a guide pin 3 when determined relative to the cutting direction. FIG. 5B illustrates one supporting devices/surfaces 6 on each side of a guide pin 3. FIG. 5C illustrates two supporting devices/surfaces 6 located behind of a guide pin 3 when determined relative to the cutting direction. FIG. 5D illustrates the guide pin 3 may comprise two guide heads located next to each other. Different designs of guide pin 3 and supporting devices/surfaces 6 are possible and so are their relative position.

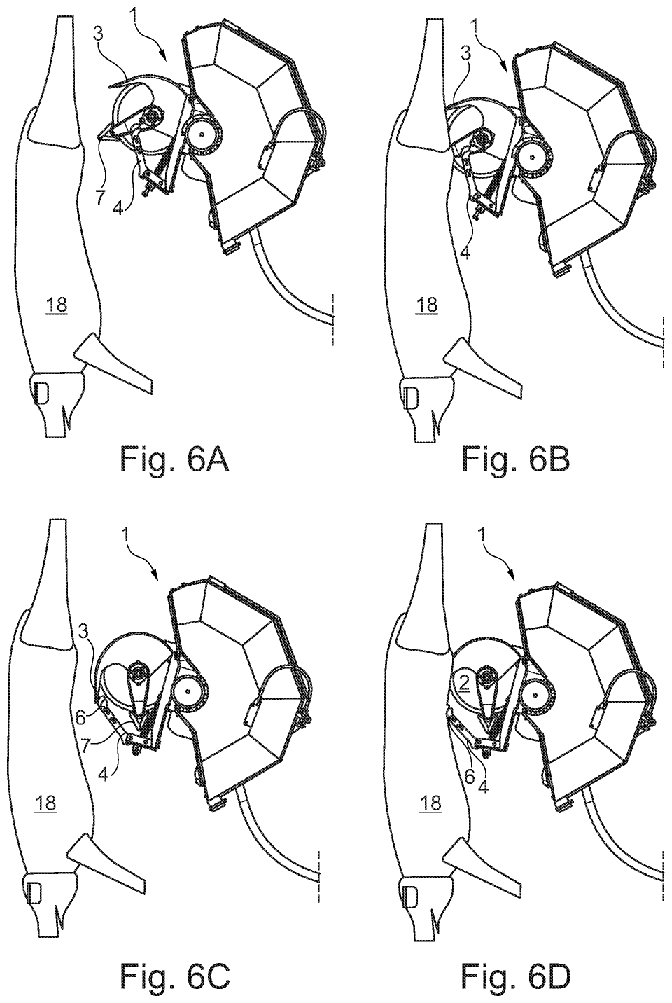

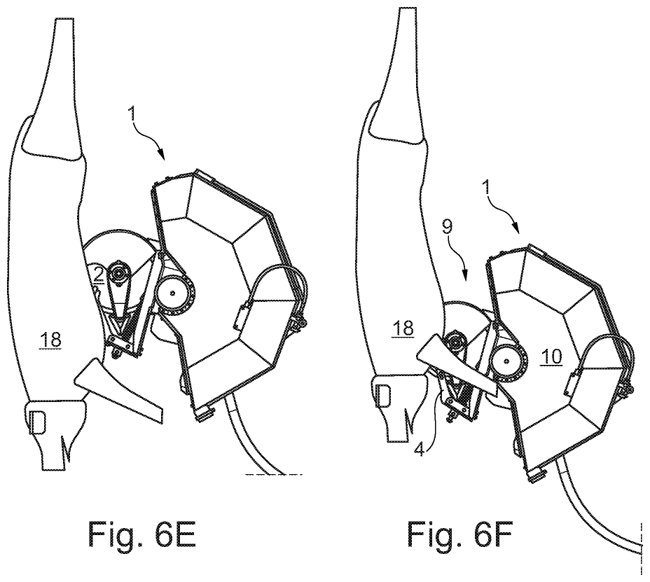

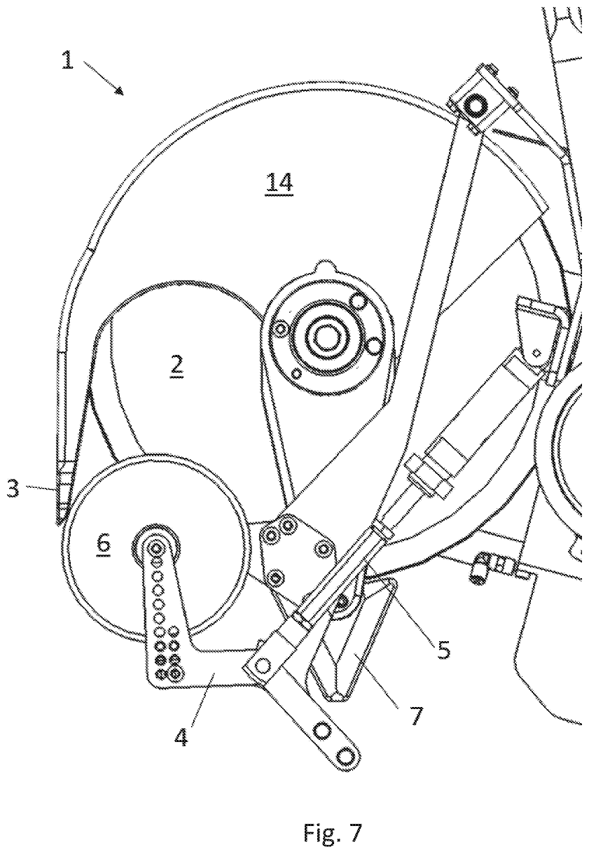

FIG. 6A-6F illustrate in six steps the process of cutting open a belly and breast of a pig carcass 18 with a cutting system 1 according to the present invention. The pig carcass 18 is hanging in its hind leg. For simplification of the figure's guides along the dorsal part of the pig carcass are not indicated, though such guides should preferably be present. Also, a robot arm, a vision system, a controlling system etc are not illustrated, but may be present in the system.

In FIG. 6A the cutting system has the second cutting device 7 in the form of a pre-cutter or pubic bone cutter pointed towards the pig carcass 18. The guide pin 3 and the pressure device 4 are both in a retracted position.

In FIG. 6B the pubic bone is being cut by the second cutting device 7 inside the carcass 18. The guide pin 3 and the pressure device 4 are still in a retracted position.

In FIG. 6C the second cutting device 7 is in a retracted position and both the guide pin 3 and the pressure device 4 are turned into an advanced position. Hereby the guide pin 3 is in a position ready to be directed inside the abdominal wall of the pig carcass 18 at the location where the pig carcass 18 was cut open by the second cutting device 7. The supporting surfaces 6 of the pressure device 4 are in a position ready to be located on the outside skin surface of the pig carcass 18.

In FIG. 6D the first cutting device 2 is cutting open the belly area of the pig carcass 18 by cutting through the abdominal wall. The guide pin 3 is located inside the pig carcass 18 behind the abdominal wall, and the pressure device 4 with its supporting surfaces 6 are located on the outside skin of the pig carcass 18, hereby stabilizing the hanging pig carcass 18.

In FIG. 6E the cutting process is ongoing along the ventral side of the pig carcass 18 and the first cutting device 2 is reaching the breast region of the pig carcass 18.

In FIG. 6F the first cutting device is cutting the sternum in the breast region of the pig carcass 18 while the guide pin is still inside the pig carcass and the supporting surfaces of the pressure device 4 are located on the outside skin surface of the pig carcass 18 pressing on the carcass 18 to stabilize the carcass 18. After finalizing the cut the tool 9 may be turned inside the cabinet 10 where it can be washed and rinsed before performing a cut in another carcass. While washing and rinsing one tool 9 an identical tool may be moved out of the cabinet 10 to perform a cut in another carcass.

FIG. 7 illustrates the tool of the cutting system 1 much like described in relation to FIG. 1, though in this embodiment the supporting surface 6 comprises at least one roller. In this side view of the tool only one roller as supporting surface 6 is visible, a second roller may be positioned on the other side of the cutting line or of the cutting device 2. A pressure device 4 together with a pressure adjusting device 5 determine the pressure and/or location of the roller. The pressure adjusting device 5 is illustrated as a cylinder. Illustrated is also a second cutting device 7 configured to cut the pubic bone.

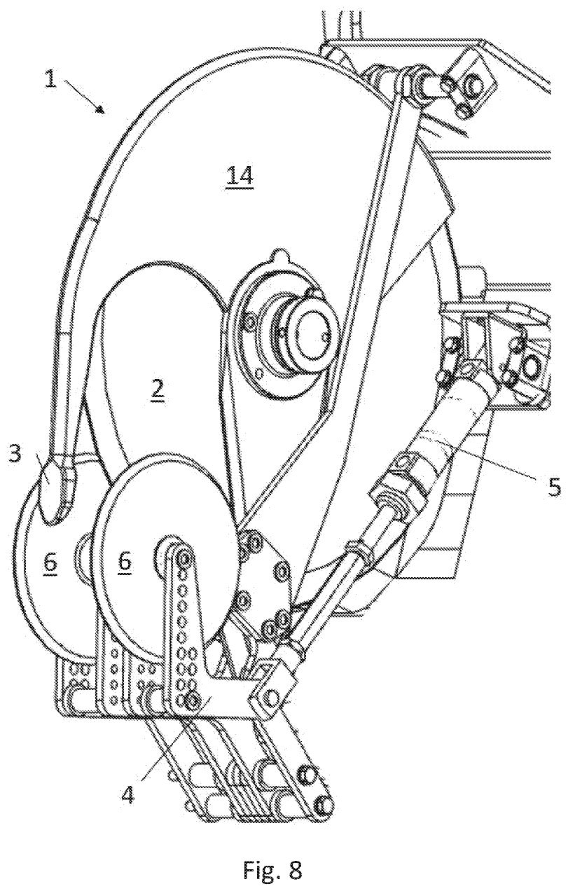

FIG. 8 is showing a similar embodiment as in FIG. 7. Illustrated are two rollers as supporting surface 6 where the two rollers are spaced apart on each side of the cutting device 2 and the guide pin 3. The size of the rollers are for illustration and may be smaller or larger compared to the cutting device 2 and/or the guide pin 3. It should be understood that the detailed description and specific examples, while indicating embodiments of the invention, are given by way of illustration only, since various changes and modifications within the spirit and scope of the invention will become apparent to those skilled in the art from this detailed description.

Items
1. A cutting system (1) for opening belly and breast of animal carcasses such as pig carcasses, the system comprising at least:
   a) A first cutting device (2) capable of cutting open the belly and breast along the ventral side of an animal carcass, and
   b) At least one guide pin (3) located next to a cutting area of the first cutting device (2), the guide pin (3) being capable of being directed along the inside of the carcass abdominal wall and capable of providing a first force on the inside of the carcass belly in at least a direction towards the cutting area of the first cutting device when the first cutting device (2) is in function, and
   c) At least one pressure device (4) located relative to the first cutting device (2) when the first cutting device (2) is in function, such that the at least one pressure device (4) provides a second force on the outside of the carcass belly and/or breast and/or neck, the second force being at least in a direction opposite of the first force, and
   d) Wherein the pressure device (4) is movable at least in the directions of the first and second force.
2. A cutting system (1) for opening belly and breast of animal carcasses such as pig carcasses, the system comprising at least:
   a) A first cutting device (2) capable of cutting open the belly and breast along the ventral side of an animal carcass, and
   b) At least one guide pin (3) located next to a cutting area of the first cutting device (2), the guide pin (3) being capable of being directed along the inside of the carcass belly skin and breastbone and capable of providing a first force on the inside of the carcass belly in at least a direction towards the cutting area of the first cutting device when the first cutting device (2) is in function, and
   c) At least one pressure device (4) located relative to the first cutting device (2) when the first cutting device (2) is in function, such that the at least one pressure device (4) provides a second force on the outside of the carcass belly and/or breast and/or neck, the second force being at least in a direction opposite of the first force, and
   d) Wherein the pressure device (4) is fixed in relation to the first cutting device (2).
3. The system according to claim 1 or 2, wherein the at least one pressure device (4) comprises at least one, supporting surface (6) configured to provide the second force to the outside of the skin of the carcass and where such supporting surface (6) is a slide or a roller.
4. The system according to claim 3, wherein the at least two supporting surfaces (6) are located symmetrically in relation to the guide pin (3) and on either side of a cutting line when the first cutting device (2) is in function
   and/or
   wherein the at least two supporting surfaces (6) are spaced apart.
5. The system according to any of the preceding claims, further comprising a pressure adjusting device (5) connected to the pressure device (4) and configured to adjust the pressure made by the supporting surfaces (6) towards the carcass
   and/or
   the system further comprises a position adjusting device (8) to adjust the position of the pressure device and configured to adjust the position of the supporting surfaces (6) on the carcass skin.
6. The system according to claim 5, wherein the pressure adjusting device (5) and the position adjusting device (8) is one common device.
7. The system according to any of claim 5 or 6, wherein the system (1) is connected to a controller for controlling at least the pressure adjusting device (5) and/or the position adjusting device (8)
   and/or
   the system comprises a robot or robot arm.
8. The system according to any of the claims 5 to 7, wherein the pressure adjusting device (5) controls the pressure device (4) to act as a counter hold for the guide pin (3) when the first cutting device (2) cuts into the belly skin and/or the pressure adjusting device (5) controls the pressure device (4) to act as a pushing device when the pressure device (4) is passing along the breast of the carcass.
9. The system according to any of the preceding claims, wherein the system (1) further comprises a second cutting device (7) configured to cut through a pubic bone of a carcass.
10. The system according to any of the preceding claims wherein at least the first cutting device (2), the at least one guide pin (3), and the at least one pressure device (4) make up a tool (9), and wherein the system (1) may comprise at least one or two tools (9) and further comprises a cabinet (10) for washing and rinsing at least one of the tools (9).
11. A method for cutting belly and breast of animal carcasses, such as pig carcasses, the method comprises at least the steps of:
   a) Directing a guide pin (3) behind abdominal wall at the pubic bone of a carcass and positioning the guide pin (3), such that the guide pin (3) performs at least a first force pressing the belly skin outwards of the carcass,
   b) Moving the guide pin (3) along the inside of the abdominal wall keeping the at least first force and simultaneously providing at least a second force to the outside of the carcass skin, which second force is opposite the first force,
   c) Cutting the carcass abdominal wall by a first cutting device (2), having a cutting area located in a skin region that is influenced by the first force and by the second force.
12. The method according to the preceding method claim, comprising the further step of
   d) When the guide pin (3) reaches the area with the breast bones, the second force is increased while the first cutting device (2) cuts through the breast bones.
13. The method according to any of the preceding method claims, wherein prior to step a) the pubic bone of the pig carcasses is cut by a second cutting device (7).
14. The method according to any of the preceding method claims, wherein the method is performed with a system of any of the claims 1 to 10
   and/or
   the method is an automatic method where sensors are used to locate the position of the carcass and/or at least the location of the pubic bone.
15. The method according to any of the preceding method claims, wherein the animal carcasses are selected from the group of animals of pig, porcine animal, goats, sheep, cows, deer, red meat, four-legged slaughtered animals
   and/or
   wherein the animal carcasses are hanging in a position with hind legs up and head down.

1.-21. (canceled)

22. A cutting system for opening belly and breast of animal carcasses such as pig carcasses, the system comprising at least:
a) a first cutting device capable of cutting open the belly and breast along the ventral side of an animal carcass, and
b) at least one guide pin located next to a cutting area of the first cutting device, the guide pin being capable of being directed along the inside of the carcass abdominal wall and capable of providing a first force on the inside of the carcass belly in at least a direction towards the cutting area of the first cutting device when the first cutting device is in function, and
c) at least one pressure device located relative to the first cutting device when the first cutting device is in function, such that the at least one pressure device provides a second force on the outside of the carcass belly and/or breast and/or neck, the second force being at least in a direction opposite of the first force,
wherein the first and second force are acting in the processing area.

23. The system according to claim 22, wherein the pressure device is movable at least in the directions of the first and second force.

24. The system according to claim 22, wherein the pressure device is fixed in relation to the first cutting device.

25. The system according to claim 22, wherein the at least one pressure device comprises at least one, such as at least two supporting surfaces configured to provide the second force to the outside of the skin of the carcass and where such supporting surface is a slide or a roller.

26. The system according to claim 25, wherein the at least two supporting surfaces are located symmetrically in relation to the guide pin and on either side of a cutting line when the first cutting device is in function and/or the at least two supporting surfaces are spaced apart.

27. The system according to claim 22, further comprising a pressure adjusting device connected to the pressure device and configured to adjust the pressure made by the supporting surfaces towards the carcass.

28. The system according to claim 22, further comprising a position adjusting device to adjust the position of the pressure device and configured to adjust the position of the supporting surfaces on the carcass skin.

29. The system according to claim 28, wherein the pressure adjusting device and the position adjusting device is one common device.

30. The system according to claim 27, wherein the system is connected to a controller for controlling at least the pressure adjusting device and/or the position adjusting device.

31. The system according to claim 27, wherein the pressure adjusting device controls the pressure device to act as a counter hold for the guide pin when the first cutting device cuts into the belly skin and/or the pressure adjusting device controls the pressure device to act as a pushing device when the pressure device is passing along the breast of the carcass.

32. The system according to claim 28, wherein the position adjusting devices can control the distance of the supporting surfaces in the three dimensions x, y, and z.

33. The system according to claim 22, wherein the system further comprises a second cutting device configured to cut through a pubic bone of a carcass.

34. The system according to claim 22, wherein at least the first cutting device, the at least one guide pin, and the at least one pressure device make up a tool, and
wherein the system may comprise at least one or two tools and further comprises a cabinet for washing and rinsing at least one of the tools.

35. A method for cutting belly and breast of animal carcasses, such as pig carcasses, the method comprises at least the steps of:
a) directing a guide pin behind abdominal wall at the pubic bone of a carcass and positioning the guide pin, such that the guide pin performs at least a first force pressing the belly skin outwards of the carcass,
b) moving the guide pin along the inside of the abdominal wall keeping the at least first force and simultaneously providing at least a second force to the outside of the carcass skin, which second force is opposite the first force, wherein the first and second force is providing a local pulling and pushing effect, and
c) cutting the carcass abdominal wall by a first cutting device, having a cutting area located in a skin region that is influenced by the first force and by the second force.

36. The method according to claim 35, comprising the further step of
d) when the guide pin reaches the area with the breast bones, the second force is increased while the first cutting device cuts through the breast bones.

37. The method according to claim 35, wherein prior to step a) the pubic bone of the pig carcasses is cut by a second cutting device.

38. The method according to claim 35, wherein the method is performed with a system comprising:
a) a first cutting device capable of cutting open the belly and breast along the ventral side of an animal carcass, and
b) at least one guide pin located next to a cutting area of the first cutting device, the guide pin being capable of being directed along the inside of the carcass abdominal wall and capable of providing a first force on the inside of the carcass belly in at least a direction towards the cutting area of the first cutting device when the first cutting device is in function, and
c) at least one pressure device located relative to the first cutting device when the first cutting device is in function, such that the at least one pressure device provides a second force on the outside of the carcass belly and/or breast and/or neck, the second force being at least in a direction opposite of the first force,
wherein the first and second force are acting in the processing area.

39. The method according to claim 35, wherein the method is an automatic method where sensors are used to locate the position of the carcass and/or at least the location of the pubic bone.

40. The method according to claim 35, wherein the animal carcasses are selected from the group of animals of pig, porcine animal, goats, sheep, cows, deer, red meat, four-legged slaughtered animals.

41. The method according to claim 35, wherein the animal carcasses are hanging in a position with hind legs up and head down.
